(19) United States
(12) Patent Application Publication
(10) Pub. No.: US 2026/0156423 A1
(43) Pub. Date: Jun. 4, 2026

(54) SYSTEM AND METHOD FOR ASSISTING PEOPLE HAVING HEARING LOSS TO LISTEN TO SPEAKERS IN A NOISY, MULTI-SPEAKER ENVIRONMENT

(71) Applicants: Dror Segal, New York, NY (US); Abraham Meidan, New York, NY (US)

(72) Inventors: Dror Segal, New York, NY (US); Abraham Meidan, New York, NY (US)

(21) Appl. No.: 19/388,011

(22) Filed: Nov. 13, 2025

Related U.S. Application Data
(60) Provisional application No. 63/726,790, filed on Dec. 2, 2024.

(51) Int. Cl. H04R 25/00; G10L 15/20; G10L 15/26; G10L 21/0272; G10L 21/0324

(52) U.S. Cl. CPC H04R 25/558; G10L 15/20; G10L 15/26; G10L 21/0272; G10L 21/0324; H04R 2225/41; H04R 2225/43; H04R 2225/55

(57) ABSTRACT

A system and method of operating a hearing aid of a user includes receiving a mixed audio signal of multiple persons speaking and noise via a hand-held device microphone, the hand-held device such as a smartphone, being operationally connected to the hearing aid. The mixed audio signal is separated into individual speech streams of the persons speaking and the noise is attenuated. The individual speech streams are input into a voice-to-text application software to convert individual speech streams into text streams. Each individual text stream is displayed on a display screen of the hand-held device. The individual text streams on the hand-held device display are selected by the user to be transmitted as audio signals to the user's hearing aid. Lastly, the selected audio signals are amplified in the user's hearing aid while the non-selected speech streams and noise are attenuated.

### BACKGROUND

A few hundred million people worldwide have hearing loss, some of whom are assisted by hearing devices. These people face difficulty listening to speakers in noisy, multi-speaker environments such as restaurants (the so-called “cocktail party problem”).

Several systems, hardware, and software have tried to address the problem by amplifying the audio signal from one direction or beam and attenuating another audio signal from a second direction. Unfortunately, these approaches are not good enough solutions: these systems fail to weigh the relevance and importance of the various speakers and therefore may fail to amplify important audio streams.

### SUMMARY

A system and method of operating a hearing aid of a user includes receiving a mixed audio signal of multiple persons speaking and noise via a hand-held device microphone, the hand-held device such as a smartphone, being operationally connected to the hearing aid. The mixed audio signal is separated into individual speech streams of the persons speaking and the noise is attenuated. The individual speech streams are input into a voice-to-text application software to convert individual speech streams into text streams. Each individual text stream is displayed on a display screen of the hand-held device. The individual text streams on the hand-held device display are selected by the user to be transmitted as audio signals to the user's hearing aid. Lastly, the selected audio signals are amplified in the user's hearing aid while the non-selected speech streams and noise are attenuated.

The method preferably includes recording the individual speech streams and/or individual text streams in the hand-held device memory. The hand-held device may be a smartphone, a tablet and/or a laptop computer. The display of the hand-held device is preferably a touchscreen. The audio signals may be separated into individual speech streams which is preferably performed using Independent Component Analysis (ICA) or Computational Auditory Scene Analysis (CASA). Furthermore, the voice-to-text application software may include the use of Google Cloud Speech-to-Text and/or Microsoft Azure Speech-to-Text.

In one embodiment, the audio signals and/or the text messages are preferably recorded in the memory of the hand-held device. Additionally, the name of the speaker(s) may be displayed on the hand-held device. The audio signals and the associated names may be input to a supervised machine-learning application that is capable of determining the speech patterns of each speaker. The determined speech patterns are preferably input to the application software, which separates the compounded audio signal into individual speech streams. The application software uses these speech patterns when separating the compounded audio signal into individual speech streams which are subsequently converted into text streams. The speaker's text stream is displayed with the associated speaker's name on the display screen of the hand-held device.

In a further embodiment, one or more words may be entered on the hand-held device. When the application software detects that at least one of these words is included in one of the text streams, a sign or symbol assigned to the text stream where the word(s) appear is displayed on the hand-held device.

This summary is a brief overview of some of the teachings of the present application and not intended to be an exclusive or exhaustive treatment of the present subject matter. Further details about the present subject matter are found in the detailed description, figures, and appended claims. The scope of the present invention is defined by the appended claims and their legal equivalents.

### BRIEF DESCRIPTION OF THE DRAWINGS

FIG. 1 illustrates a system and method for processing a plurality of audio signals from persons speaking for selective amplification to a hearing device.

FIG. 2 is a flow chart illustrating an exemplary embodiment of a method for selectively amplifying at least one audio signal from a plurality of audio signals to a hearing device.

### DETAILED DESCRIPTION

The present invention provides an innovative solution that analyzes the compound audio signals of a plurality of speakers and allows the users to select the speaker to whom they want to listen. The disclosed system an audio processing algorithm are capable of advanced real-time sound manipulation including listening, filtering, speaker separation and audio enhancement. The system can be implemented entirely within a single device such as a smartphone, hearing aid, tablet or computer. Alternatively, the system's functional components can be distributed across multiple interconnected devices.

An external or built-in microphone(s) connected to a hand-held device such as a smartphone, tablet and/or laptop computer receives the mixed audio signal of several speakers and noise.

The audio signal is transferred to a system that attenuates the noise and separates the audio signal into individual speech streams, one stream per speaker. Electronic recognizing and separating multiple speakers in an audio stream is often referred to as speaker diarization which involves determining who spoke when in an audio stream, identifying individual speakers, and separating their speech into distinct tracks. This stage is preferably performed by an external system such as: ICA-Independent Component Analysis, or Computational Auditory Scene Analysis (CASA).

The separated audio speech streams of the speakers are transferred to a voice-to-text software application that converts the audio speech streams into respective text streams, one per speaker. This stage is preferably performed by an external system such as Google Cloud Speech-to-Text, Microsoft Azure Speech-to-Text, and/or Adobe Premier. The text streams associated with identified speakers are preferably continuously displayed on the display screen of the hand-held device which preferably includes a touch-screen.

The user can then select one or more than one of the individual text streams displayed on the hand-held device. Upon user selection, the audio signal(s) of the speaker(s) associated with the selected text stream(s) is amplified in the user's hearing device, e.g., earphones, while the other non-selected audio signals of the speakers and the noise are attenuated with respect to the hearing device, e.g., any current generation hearing aid that supports Bluetooth LE Audio (LBE) and/or Auracast is suitable for use with the system. Examples of such hearing aids include, but are not limited to, ReSond Nexia, Jabra Enhance Select models (500, 300, 50R) and Philips brand hearing aids working with Bluetooth LE Audio. Alternatively, the hearing device may be in the form of wired or wireless earbuds connected to a smartphone. Both the hearing aids and earbuds can operate as audio output devices, playing audio that has been processed, attenuated, and amplified by the disclosed system.

In one embodiment, the user has the option to record the audio signal and/or the text messages in the memory of the hand-held device.

In a further embodiment, the user can enter the name of the speaker(s) on the display of the hand-held device. The audio signals and the associated names are preferably transferred to a supervised machine-learning application, such as IBM Watson. Such systems are capable of determining the patterns of each speaker. The determined patterns are transferred to the application software, which separates the compounded audio signal into individual speech streams. The application software uses these patterns when separating the compounded audio signal. Preferably, the speaker's text stream is displayed with the associated speaker's name on the display screen of the hand-held device.

In another embodiment, the user enters one or several words on the hand-held device, such as the names of the speakers which are to be part of the conversation and separated out from other speakers. When the application software detects that one of these words is included in one of the text streams, it will preferably display a sign assigned to the stream text where the word(s) appears.

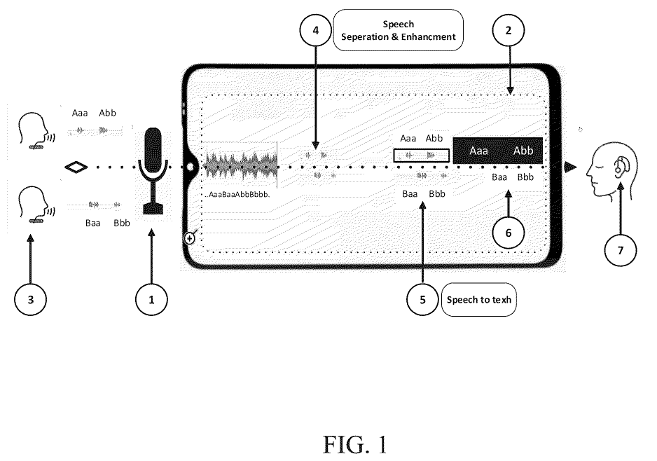

With reference to FIG. 1, the method and apparatus for operating a hearing aid of a user includes the user's microphone (1) which can be built into a hand-held device such as a smartphone, tablet and/or laptop computer (2) or an external microphone connected to e.g., the smartphone. The microphone (1) receives a voice signal (3) of several speakers and noise. The audio signal, which may include the voice signals of a plurality of speakers, is preferably transferred to an external system (4) that separates and enhances the audio signal into individual speech streams, one stream per speaker, and removes the noise. The individual speech streams are preferably transferred to another external system (5) that performs voice-to-text for the streams of each speaker. The text streams of each speaker are displayed on e.g., a smartphone touch screen display (6). Preferably the text stream of each speaker is displayed on separate lines for ease of identification. The user can then select to listen to one or several speakers. The speech streams of the selected speaker(s) are amplified, while the non-selected speech streams and the noise are attenuated in the listener's earphones (7) that are connected to the smartphone (2).

Preferably, the method and apparatus for operating a hearing aid to select a speaker in a multi-speaker environment has a latency below 10 milliseconds. This is accomplished by the use of optimized algorithms, correctly? improved device processing capabilities and the use of Bluetooth Low Energy Audio (LE Audio) and Auracast, which offer improved synchronization and latency control.

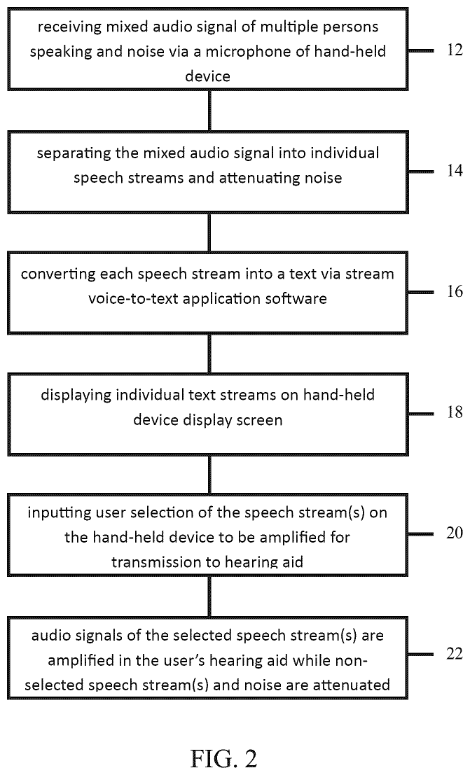

FIG. 2 is a flowchart related to the method of operating a user's hearing aid in an environment which includes a plurality of speakers. The method includes the steps of receiving on a hand-held device microphone, a mixed audio signal of multiple personal speaking and noise 12. The audio signal is separated into individual speech streams and the noise is attenuated 14. The separated speech streams are input into a voice-to-text application software to convert each of the speech streams into an individual text stream 16. The individual text streams are displayed on the hand-held device display screen, such as a smartphone touch screen 18. On the hand-held device, the user selects one or more text streams associated with the speech stream that the user wants to listen to. The selected text stream is transmitted as an audio signal to the user's hearing aid 20. The audio signals of the selected speech stream(s) are amplified in the user's hearing aid while non-selected speech stream(s) and noise are attenuated 22.

Hearing devices typically include at least one enclosure or housing, a microphone, hearing device electronics including processing electronics, and a speaker or “receiver.” Hearing devices may include a power source, such as a battery. In various embodiments, the battery may be rechargeable. In various embodiments, multiple energy sources may be employed. It is understood that in various embodiments the microphone is optional. It is understood that in various embodiments the receiver is optional. It is understood that variations in communications protocols, antenna configurations, and combinations of components may be employed without departing from the scope of the present subject matter. Antenna configurations may vary and may be included within an enclosure for the electronics or be external to an enclosure for the electronics. Thus, the examples set forth herein are intended to be demonstrative and not a limiting or exhaustive depiction of variations.

It is understood that digital hearing aids include a processor. For example, control circuitry and/or controllers may each be implemented in such a processor. In digital hearing aids with a processor, programmable gains may be employed to adjust the hearing aid output to a wearer's particular hearing impairment. The processor may be a digital signal processor (DSP), microprocessor, microcontroller, other digital logic, or combinations thereof. The processing may be done by a single processor, or may be distributed over different devices. The processing of signals referenced in this application can be performed using the processor or over different devices. Processing may be done in the digital domain, the analog domain, or combinations thereof. Processing may be done using subband processing techniques. Processing may be done using frequency domain or time domain approaches. Some processing may involve both frequency and time domain aspects. For brevity, in some examples drawings may omit certain blocks that perform frequency synthesis, frequency analysis, analog-to-digital conversion, digital-to-analog conversion, amplification, buffering, and certain types of filtering and processing. In various embodiments the processor is adapted to perform instructions stored in one or more memories, which may or may not be explicitly shown. Various types of memory may be used, including volatile and nonvolatile forms of memory. In various embodiments, the processor or other processing devices execute instructions to perform a number of signal processing tasks. Such embodiments may include analog components in communication with the processor to perform signal processing tasks, such as sound reception by a microphone, or playing of sound using a receiver (i.e., in applications where such transducers are used). In various embodiments, different realizations of the block diagrams, circuits, and processes set forth herein can be created by one of skill in the art without departing from the scope of the present subject matter.

Various embodiments of the present subject matter support wireless communications with a hearing device. In various embodiments the wireless communications can include standard or nonstandard communications. Some examples of standard wireless communications include, but not limited to, Bluetooth™, low energy Bluetooth, IEEE 802.1 l(wireless LANs), 802.15 (WP AN s) , and 802.16 (WiMAX). Cellular communications may include, but not limited to, CDMA, GSM, ZigBee, and ultra-wideband (UWB) technologies. In various embodiments, the communications are radio frequency communications. In various embodiments the communications are optical communications, such as infrared communications. In various embodiments, the communications are inductive communications. In various embodiments, the communications are ultrasound communications. Although embodiments of the present system may be demonstrated as radio communication systems, it is possible that other forms of wireless communications can be used. It is understood that past and present standards can be used. It is also contemplated that future versions of these standards and new future standards may be employed without departing from the scope of the present subject matter.

The wireless communications support a connection from other devices. Such connections include, but are not limited to, one or more mono or stereo connections or digital connections having link protocols including, but not limited to 802.3 (Ethernet), 802.4, 802.5, USB, ATM, Fibre-channel, Firewire or 1394, InfiniBand, or a native streaming interface. In various embodiments, such connections include all past and present link protocols. It is also contemplated that future versions of these protocols and new protocols may be employed without departing from the scope of the present subject matter.

In various embodiments, the present subject matter is used in hearing devices that are configured to communicate with mobile phones. In such embodiments, the hearing device may be operable to perform one or more of the following: answer incoming calls, hang up on calls, and/or provide two way telephone communications. In various embodiments, the present subject matter is used in hearing devices configured to communicate with packet-based devices. In various embodiments, the present subject matter includes hearing devices configured to communicate with streaming audio devices. In various embodiments, the present subject matter includes hearing devices configured to communicate with Wi-Fi devices. In various embodiments, the present subject matter includes hearing devices capable of being controlled by remote control devices.

It is further understood that different hearing devices may embody the present subject matter without departing from the scope of the present disclosure. The devices depicted in the figures are intended to demonstrate the subject matter, but not necessarily in a limited, exhaustive, or exclusive sense. It is also understood that the present subject matter can be used with a device designed for use in the right ear or the left ear or both ears of the wearer.

The present subject matter may be employed in hearing devices, such as hearing aids, ear buds, headsets, headphones, and similar hearing devices.

Although preferred embodiments have been described herein with reference to the accompanying drawings, it is to be understood that the disclosure is not limited to those precise embodiments and that various other changes and modifications may be affected herein by one skilled in the art without departing from the scope or spirit of the embodiments, and that it is intended to claim all such changes and modifications that fall within the scope of this disclosure.

What is claimed is:

1. A method of operating a hearing aid of a user, the method comprising:
receiving a mixed audio signal of multiple persons speaking and noise via a hand-held device microphone, the hand-held device being operationally connected to the hearing aid;
separating the mixed audio signal into individual speech streams of the persons speaking and attenuating the noise;
inputting the individual speech streams into a voice-to-text application software to convert each individual speech stream into a text stream;
displaying each individual text stream on a display screen of the hand-held device;
selecting the individual text streams on the hand-held device display to be transmitted as audio signals to the user's hearing aid; and
amplifying the selected audio signals in the user's hearing aid while the non-selected speech streams and noise are attenuated.

2. The method of claim 1, wherein the individual speech streams and/or individual text streams are recorded in the hand-held device memory.

3. The method of claim 1, wherein the hand-held device is a smartphone, a tablet and/or a laptop computer.

4. The method of claim 1, wherein the display of the hand-held device is a touchscreen.

5. The method of claim 1, wherein separating the audio signals into individual speech streams is performed using Independent Component Analysis (ICA) or Computational Auditory Scene Analysis (CASA).

6. The method of claim 1, wherein the voice-to-text application software comprises Google Cloud Speech-to-Text or Microsoft Azure Speech-to-Text.

7. The method of claim 1, wherein the audio signals and/or the text messages are recorded in memory of the hand-held device.

8. The method of claim 1, wherein a name of the speaker(s) are input to the hand-held device for display on the display screen, and further wherein the audio signals and the names are input to a supervised machine-learning application that determines the speech patterns of each speaker, the determined speech patterns are separated from the audio signals into individual speech streams, and wherein the text streams are displayed with the associated speaker's name on the display screen of the hand-held device.

9. The method of claim 1, wherein one or several words are input to the hand-held device and, when one of the words is included in one of the text streams, the hand-held device displays a sign assigned to the text stream where the word(s) appears.
